(19) United States
(12) Patent Application Publication
(10) Pub. No.: US 2007/0177012 A1
(43) Pub. Date: Aug. 2, 2007

(54) Image display apparatus for mounting on vehicle

(75) Inventors: Yoshiaki Ogawara, Tokyo (JP); Hidemi Takakuwa, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/578,864

(22) PCT Filed: Apr. 14, 2005
(86) PCT No.: PCT/JP05/07578

§ 371 Date: Oct. 19, 2006

(30) Foreign Application Priority Data
Apr. 19, 2004 (JP) 2004-012336

(51) Int. Cl. H04N 7/18

(52) U.S. Cl. 348/118

(57) ABSTRACT

For an object for displaying output images of a plurality of imaging means equipped in a vehicle concurrently in a form in which the positional relation thereof can be comprehended easily, there are provided with projection means 30 for projecting output images of a plurality of imaging means; and a plurality of hologram films 21, 22 and 23 in which the output image of the projection means 30 is projected, a projection image is displayed imaginarily at a position different from an actual arrangement position, and at the same time the position on which the projection image is displayed imaginarily is made to be at lease two different positions. For a viewer seeing an image projected to the hologram films 21, 22 and 23, it looks such that a plurality of images are displayed at different positions and it becomes easy to comprehend which image picture it is imaged by an imaging means arranged at which position according to the image positional relation thereof.

### TECHNICAL FIELD

The present invention relates to an image display apparatus for a vehicle equipped in a vehicle such as a car or the like and more particularly relates to an image display apparatus which includes a plurality of imaging means and displays image pictures imaged by the plurality of imaging means.

### BACKGROUND ART

In the past, various kinds of apparatuses were used practically in which it is constituted such that an imaging means such as a video camera or the like is mounted in a vehicle such as a car or the like and the image picture imaged by the imaging means is displayed on a display apparatus provided in the vicinity of a driving seat so as to make it possible to monitor positions which become dead zones from the driver. For example, in a case when backing the vehicle under a condition of mounting a video camera which images the rear portion of the vehicle, there has been generalized an apparatus in which it is constituted such that the driver can confirm the image picture imaged by the video camera.

For a position at which the video camera is arranged on the vehicle, it has been proposed to arrange not only at the rear portion of the vehicle but also at other positions in order to make is possible to monitor more dead zones of the vehicle environment and they have been used practically. For example, an apparatus was proposed in which total three of video cameras are installed at a back portion and right and left side portions of a vehicle and three of images imaged by the three of video cameras are synthesized and displayed on a display apparatus for a navigation apparatus. More specifically, as shown, for example, in FIG. 26, one display of a landscape shape is arranged in a console 1 arranged ahead of a driving seat of a car, in which the center of the display is made to be a display area 2 of a backward image, the right end thereof is made to be a display area 3 of a right backward image and the left end thereof is made to be a display area 4 of a left backward image, so as to be used as a so-called multi-image display. The display areas 2, 3 and 4 are aligned laterally on the plane seen from an observing point e of the driver.

In a Japanese unexamined patent publication No. 2001-114048 (particularly in FIG. 2) issued by the Japanese Patent Office, there is a disclosure with respect to a matter in which three of images imaged by three of video cameras in this manner are displayed concurrently on one display screen included in a display apparatus by being divided into three.

However, as described in the Japanese unexamined patent publication No. 2001-114048, there was a problem, if a plurality of imaged pictures are to be displayed concurrently on one display screen, that it is difficult to comprehend which images the respective images correspond to which positions imaged. In a display example of FIG. 2 described in the Patent Document 1, it is constituted such that positional relations can be comprehended in its own way by displaying imaged picture of the back at the center of the screen, by displaying imaged picture of the left side portion on the left of the screen and by displaying imaged picture of the right side portion on the right of the screen. However, the three of images are only aligned on a flat screen and skill is necessary until a driver comprehends accurate positional relations in one glance, so that it was difficult to say that it is exactly a desirable display form.

An object of the present invention is to display output images of a plurality of imaging means equipped in a vehicle concurrently in a form in which positional relations can be easily comprehended.

### DISCLOSURE OF THE INVENTION

The present invention relates to an apparatus wherein in case of displaying outputs of a plurality of imaging means imaging positions of different directions respectively, there are provided with projection means for projecting the output images of the plurality of imaging means; and a plurality of hologram films in which the output image of the projection means is projected, a projection image is displayed imaginarily at a position different from an actual projected arrangement position, and at the same time the position on which the projection image is displayed imaginarily is made to be at lease two different positions.

By doing in this manner, for a viewer seeing an image projected to the hologram film, it looks such that a plurality of images are displayed at different positions, it is easy to comprehend which image picture it is imaged by an imaging means arranged at which position according to the image positional relation thereof, and it becomes possible to discriminate the displayed images easily.

### BRIEF DESCRIPTION OF DRAWINGS

FIG. 1 is an explanatory diagram showing a display constitutional example according to a first exemplified embodiment of the present invention;

FIG. 2 is a plan view showing a camera arrangement example according to the first exemplified embodiment of the present invention;

FIG. 3 is a block diagram showing a block constitutional example of circuits according to the first exemplified embodiment of the present invention;

FIG. 4 is a cross section diagram showing an example of a wide-angle azimuth projector according to the first exemplified embodiment of the present invention;

FIG. 5 is a top view showing an example of the wide-angle azimuth projector according to the first exemplified embodiment of the present invention;

FIG. 6 is a cross section diagram showing a display constitutional example according to the first exemplified embodiment of the present invention;

FIG. 7 is a cross section diagram showing a display constitutional example according to a second exemplified embodiment of the present invention;

FIG. 8 is an explanatory diagram showing a display constitutional example according to the second exemplified embodiment of the present invention;

FIG. 9 is a cross section diagram showing a display constitutional example according to a third exemplified embodiment of the present invention;

FIG. 10 is an explanatory diagram showing a display constitutional example according to the third exemplified embodiment of the present invention;

FIG. 11 is a cross section diagram showing a display constitutional example according to a fourth exemplified embodiment of the present invention;

FIG. 12 is a cross section diagram showing a display constitutional example according to a fifth exemplified embodiment of the present invention;

FIG. 13 is a cross section diagram showing a display constitutional example according to a sixth exemplified embodiment of the present invention;

FIG. 14 is an explanatory diagram when seeing the display apparatus of the FIG. 13 example from the front thereof;

FIG. 15 is a cross section diagram showing a display constitutional example according to a seventh exemplified embodiment of the present invention;

FIG. 16 is an explanatory diagram when seeing the display apparatus of the FIG. 15 example from the front thereof;

FIG. 17 is a cross section diagram showing a display constitutional example according to an eighth exemplified embodiment of the present invention;

FIG. 18 is an explanatory diagram when seeing the display apparatus of the FIG. 17 example from the front thereof;

FIG. 19 is a cross section diagram showing a display constitutional example according to a ninth exemplified embodiment of the present invention;

FIG. 20 is an explanatory diagram when seeing the display apparatus of the FIG. 19 example from the front thereof;

FIG. 21 is an explanatory diagram showing a display constitutional example according to a tenth exemplified embodiment of the present invention;

FIG. 22 is a cross section diagram showing a display constitutional example according to an eleventh exemplified embodiment of the present invention;

FIG. 23 is an explanatory diagram showing a display constitutional example according to the eleventh exemplified embodiment of the present invention;

FIG. 24 is an explanatory diagram showing a display constitutional example according to a twelfth exemplified embodiment of the present invention;

FIG. 25 is a cross section diagram showing a display constitutional example according to a thirteenth exemplified embodiment of the present invention; and

FIG. 26 is an explanatory diagram showing a multi-image display constitutional example in the past.

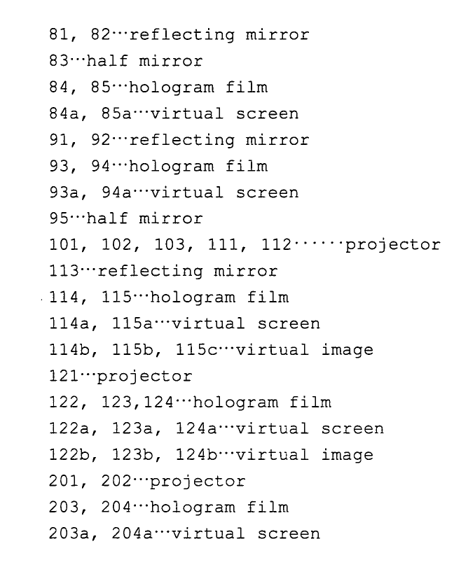

### BEST MODE FOR CARRYING OUT THE INVENTION

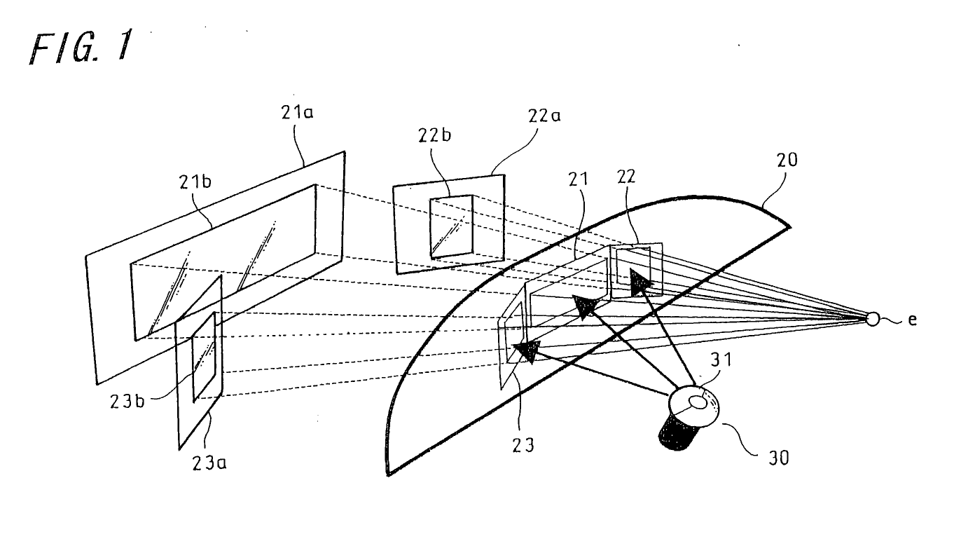

Hereinafter, a first exemplified embodiment of the present invention will be explained with reference to FIG. 1 to FIG. 6.

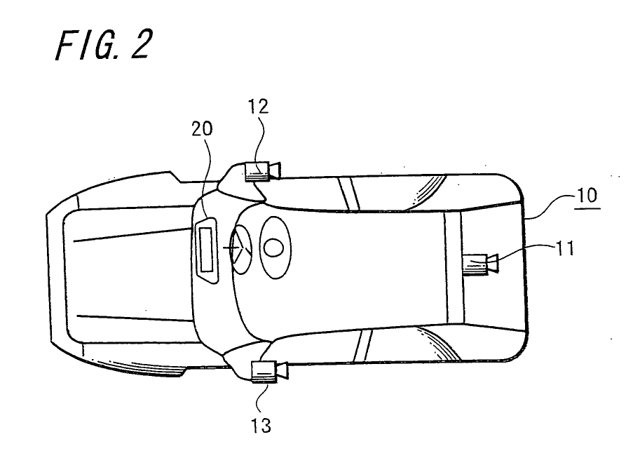

In this example, the apparatus is constituted as an image display apparatus for a vehicle equipped in a vehicle such as a car. First, with reference to FIG. 2, it will be explained with respect to an arrangement position of an image display apparatus for a vehicle equipped in a vehicle of this example and to an arrangement of video cameras as imaging means for imaging pictures which the display apparatus displays. As shown in FIG. 2, in a vehicle 10, a rear center camera 11 as a video camera for imaging back center is arranged at the rear end thereof, a rear right camera 12 as a video camera for imaging back right from the right side portion is arranged at the right side portion thereof, and a rear-left camera 13 as a video camera for imaging back left from the left side portion is arranged at the left side portion.

Then, an image display apparatus of this example is arranged in a console 20 ahead a driving seat, wherein images imaged (taken pictures) by each of the cameras 11, 12 and 13 are displayed on this image display apparatus. The image display of camera imaging in this image display apparatus is utilized on an occasion, for example, of a lane change while the vehicle is moving.

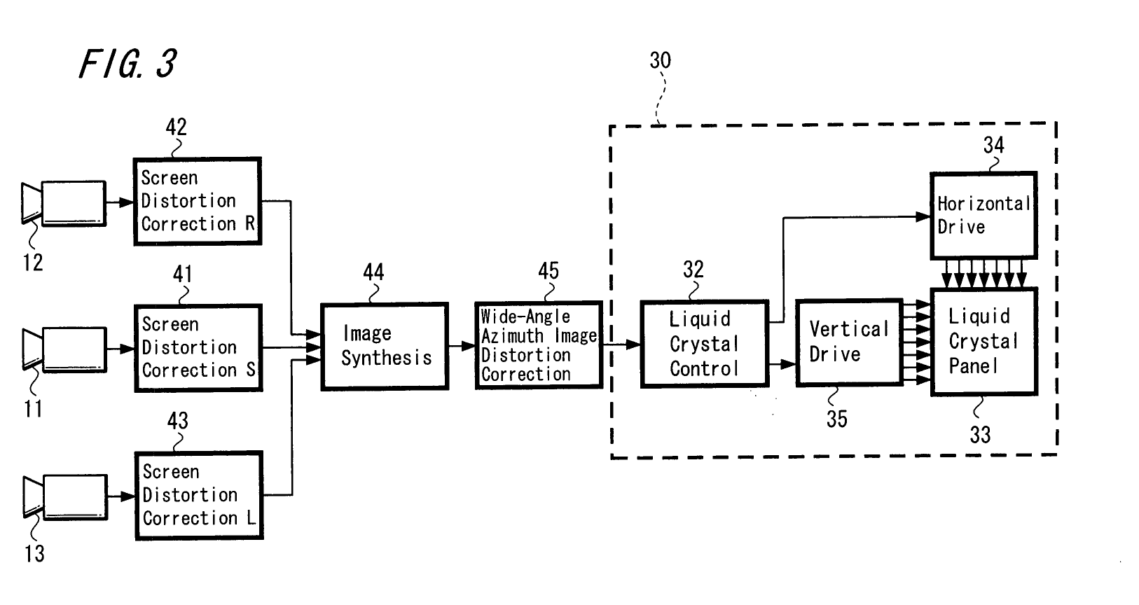

FIG. 3 is a diagram showing a circuit block constitutional example of an image display apparatus of this example. An output of an imaged signal of the rear center camera 11, an output of an imaged signal of the rear right camera 12 and an output of an imaged signal of the rear left camera 13 are supplied to screen distortion correction circuits 41, 42 and 43 respectively in which screen distortion corrections for matching with modes to be displayed in the image display apparatus are carrying out. Then, imaged outputs of the three of cameras 11, 12 and 13 which were corrected in the respective screen distortion correction circuits 41, 42 and 43 are supplied to an image synthesis circuit 44. In the image synthesis circuit 44, a synthesizing process for making the respective imaged outputs to be one video signal is carrying out. Here, an image synthesizing process is carried out in which the imaged image of the rear center camera 11 is displayed at the center of one image, the imaged image of the rear right camera 12 is displayed on the right side thereof and the imaged image of the rear left camera 13 is displayed on the left side thereof.

A video signal which the image synthesis circuit 44 outputs is supplied to a wide-angle azimuth image distortion correction circuit 45, wherein a wide-angle azimuth image distortion correction is carried out such that correct images could be displayed on respective display positions when it is supplied to a wide-angle azimuth projector 30 described hereinafter which is used as a display-means in this example. For the wide-angle azimuth projector 30, here, a liquid crystal display panel 33 as an image display means is used and an output of the image distortion correction circuit 45 is supplied to a liquid crystal panel control unit 32 which controls the display in this liquid crystal display panel 33. The liquid crystal panel control unit 32 supplies corresponding control signals to a horizontal drive unit 34 and a vertical drive unit 35 which carry out display drives in the liquid crystal display panel 33 based on supplied video signals so as to display images according to the video signal inputted to the liquid crystal display panel 33.

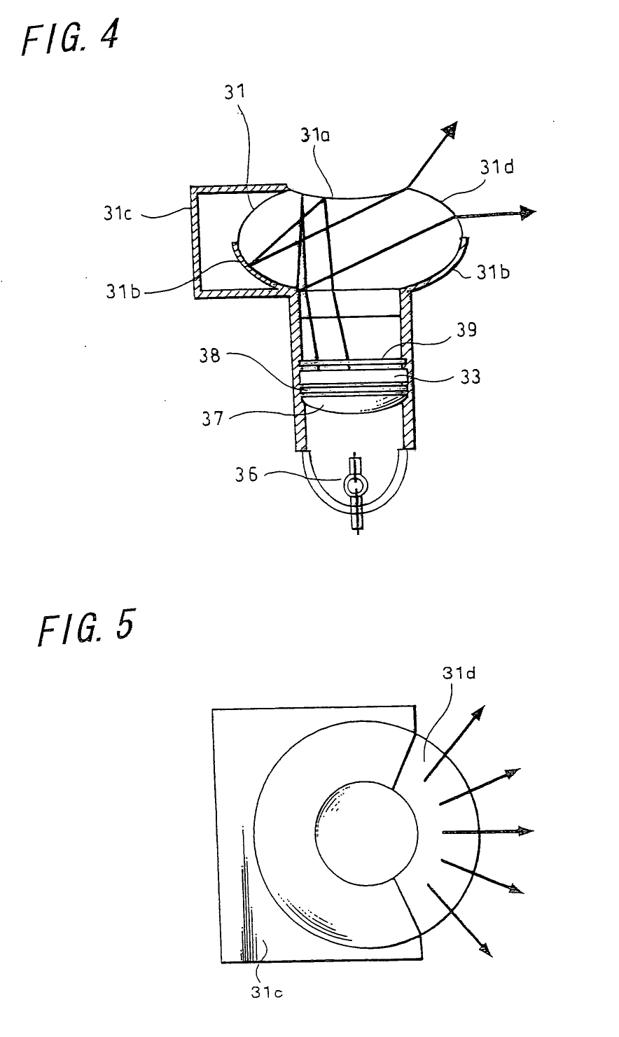

FIG. 4 is a cross section diagram showing a constitutional example of the wide-angle azimuth projector 30 of this example. The wide-angle azimuth projector 30 as a projection means used in this example is a wide-angle azimuth projector having an optical system in which 360° projection is possible. Here, it is constituted by using the optical system in which 360° projection is possible such that the projection is to be performed by a limited angle, wherein projection angles (and image display positions) are set so as to project onto three of screens (actually, onto hologram films described hereinafter).

It will be explained with respect to the constitution of the wide-angle azimuth projector 30 of this example, wherein light from a light source 36 as a point light source constituted by a xenon lamp or the like is inputted to the liquid crystal display panel 33 as approximately parallel light through a focusing lens 37 and a polarizing plate 38 and images displayed on the liquid crystal display panel 33 are projected. Light outputted from the liquid crystal display panel 33 is inputted to the projection lens 31 through a polarizing plate 39. The projection lens 31 of this example is in a circular form having a shape such as being obtained by crushing a sphere at the top and the bottom thereof and it is constituted such that the bottom face to which the light outputted from the liquid crystal display panel 33 inputs has a planar surface, the top portion hit by the light inputted from that bottom face has a reflection portion 31a is curved to be a concave surface, and the incident light is to be distributed equally for 360° by the reflection at the reflection portion 31a.

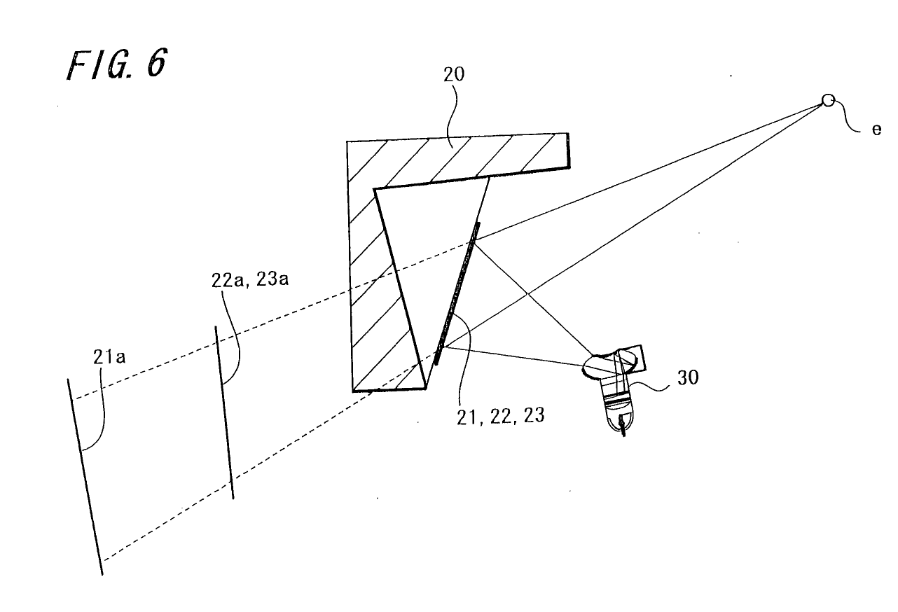

The incident light reflected by the reflection portion 31a is reflected by a reflection portion 31b of a lower half of the side face projecting in convexity and is outputted from a transparent portion 31d of an upper half of the side face facing to the reflected position by 180° and is projected. It should be noted in case of this example, as shown in FIG. 4 shown by a cross section and in FIG. 5 shown by a view seen from the top, that it is constituted such that a light shielding member 31c is arranged beforehand in a direction in which the projection light is not outputted and the light is not to be leaked from unnecessary directions of the projection lens 31. The wide-angle azimuth projector 30 constituted in this manner is arranged in the console 20 shown in FIG. 2 according to this example and it is constituted such that images projected from the wide-angle azimuth projector 30 can be seen when a driver sees the console 20.

FIG. 1 is a diagram showing a constitution in which images projected from the wide-angle azimuth projector 30 are displayed. In this example, the wide-angle azimuth projector 30 is arranged on the downside near the front side of the console 20 in which the image light projected from the projection lens 31 is projected to the three of hologram films 21, 22 and 23 arranged in the console 20. The three of hologram films 21, 22 and 23 are arranged laterally in one row in which it is constituted such that the central hologram film 21 is made to be a landscape shape, he hologram films 22 and 23 of the immediate right and the immediate left thereof are arranged by being inclined slightly obliquely so as to display images obliquely with a predetermined angle. By arranging the right and the left hologram films 22 and 23 inclined obliquely seen from an observing point e of a driver in this manner, the three of hologram films 21, 22 and 23 are arranged in a manner such as surrounding the driver and then images are displayed.

The respective hologram films 21, 22 and 23, as shown in FIG. 1, are made to be hologram films having constitutions in which screens 21a, 22a and 23a can be seen imaginarily at the back (backward) as compared with the positions at which the films 21, 22 and 23 are arranged actually when seeing from the observing point e of the driver. The hologram film is a film in which images can be seen at a position different from the position at which the film is arranged actually by utilizing an interference phenomenon of the light. The screens 21a, 22a and 23a which can be seen imaginarily by utilizing these hologram films will be referred to as virtual screens and the images which can be seen on the virtual screens will be referred to as virtual images in the explanation hereinafter.

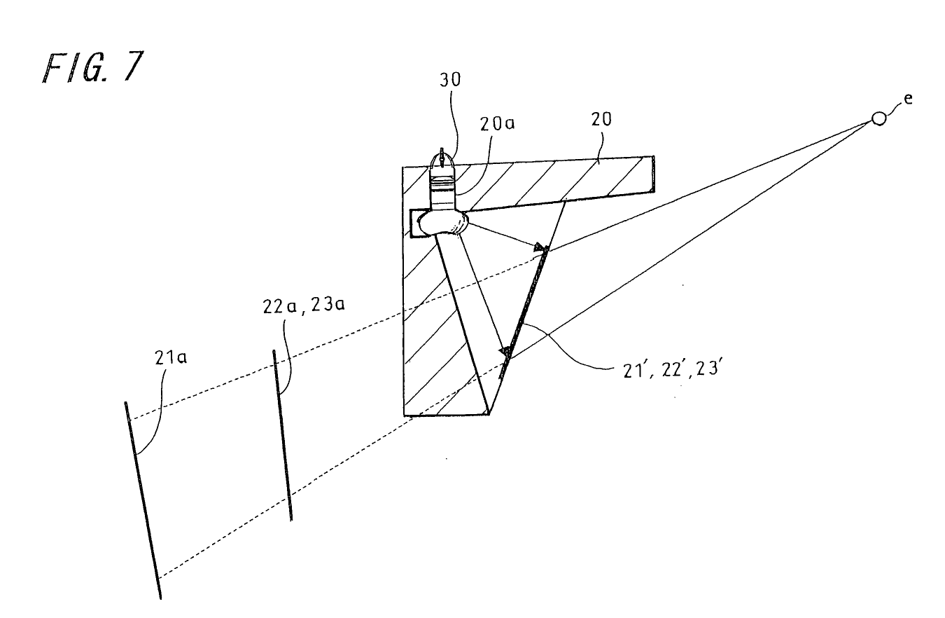

Here, it is constituted in this example such that the position of the first virtual screen 21a displayed by the central hologram film 21 and the position of the of the second and the third virtual screen 22a and 23a displayed by the right and left hologram films 22 and 23 are made to be different positions. Specifically, it is constituted as shown in FIG. 1 such that the distance from the driver observing point e to the virtual screen 22a or 23a is made to be shorter than the distance from the driver observing point e to the virtual screen 21a. FIG. 6 is a diagram showing a setting example of the distances from the driver observing point e to the virtual screens 21a, 22a and 23a by a cross section of the console 20.

Then, it is constituted such that an image (virtual image 21b) imaged by the rear center camera 11 (FIG. 2) will be displayed on the first virtual screen 21a displayed by the central hologram film 21. It is constituted such that an image (virtual image 22b) imaged by the rear right camera 12 (FIG. 2) will be displayed on the second virtual screen 22a displayed by the hologram film 22 on the right side. It is constituted such that an image (virtual image 23b) imaged by the rear left camera 13 (FIG. 2) will be displayed on the third virtual screen 23a displayed by the hologram film 23 on the left side. It should be noted with respect to portions other than the virtual image display regions of the respective virtual screens 21a, 22a and 23a that the screen itself cannot be seen, because there is no image projection at all from the wide-angle azimuth projector 30.

By constituting in this manner, as shown in FIG. 1, with respect to an image seen from the driver observing point e, the virtual image 21b imaged by the rear center camera 11 is displayed at the back center of the console 20 and the virtual images 22b and 23b imaged by the rear right camera 12 and the rear left camera 13 are displayed by being inclined obliquely on the right and left slightly before the virtual image 21b. Consequently, the three of virtual images 21b, 22b and 23b are displayed at the back of the console 20 in a state such as surrounding the driver, the image 21b imaging the rear portion of the vehicle and the images 22b and 23b imaging the right and left side portions are to be displayed by different positional relations respectively, a display positional relation approximately equal to the actually imaging positional relation (however, back and front are opposite, so that right and left are reversed actually) can be realized, and it becomes a display mode in which the positional relation between the rear portion and the right and left side portions can be easily comprehended. Further, in this example, with respect to the images 22b and 23b imaging the right and left side portions, the images of the right and left side portions are displayed in a form closer to the actual imaging directions owing to the fact that the positions are made to be obliquely displayed with a predetermined angle in which it becomes easy to comprehend that they are the right and left side portions.

Also, in this example, the wide-angle azimuth projector 30 shown in FIG. 4 and FIG. 5 is used as projection means for displaying the three of virtual images 21b, 22b and 23b on different positions, so that it is enough if there is only provided with one projection means and it is possible to make the constitution for the image display to be simple.

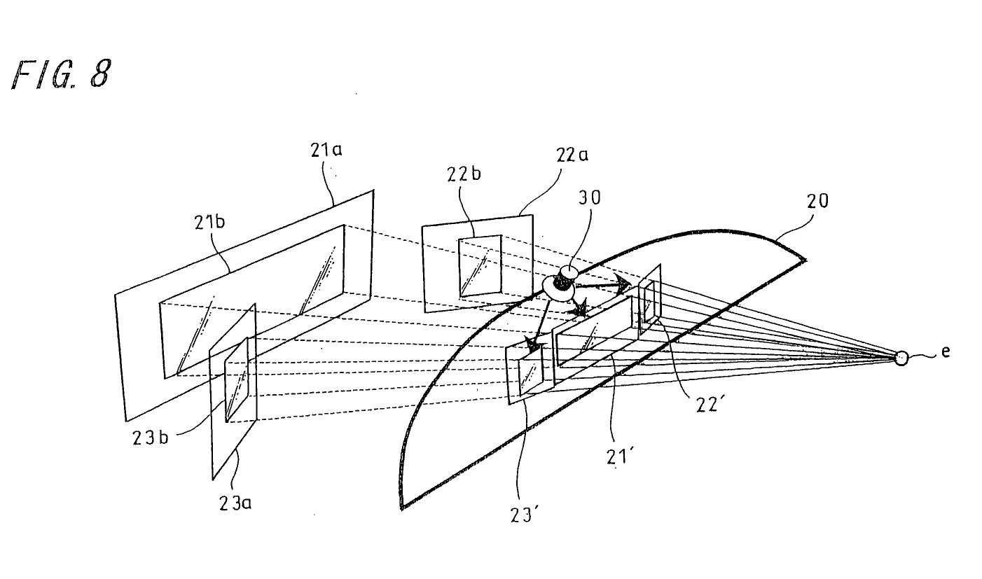

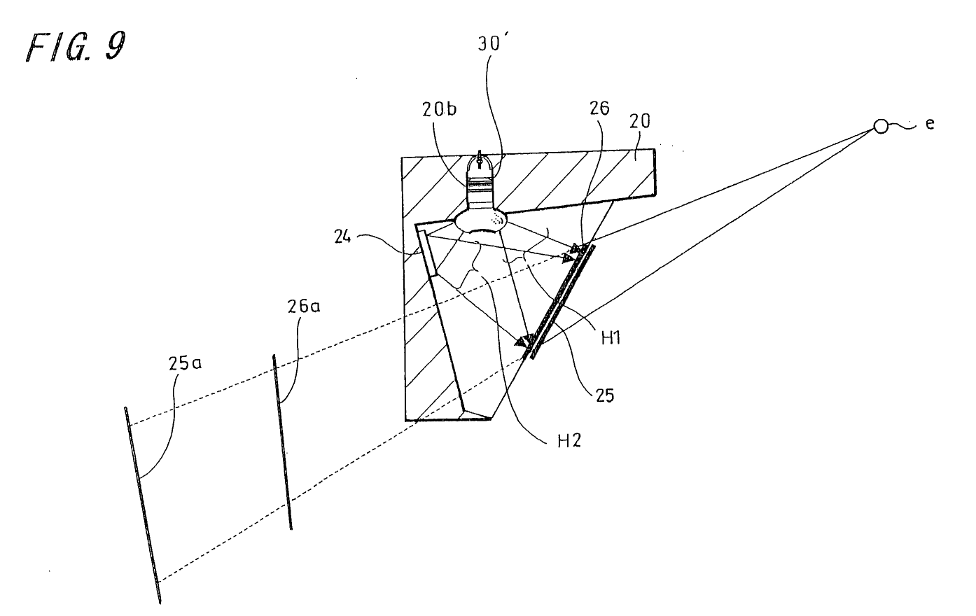

Next, a second exemplified embodiment of the present invention will be explained with reference to FIG. 7 and FIG. 8. In these FIG. 7 and FIG. 8, the same reference numerals are put for the portions corresponding to those of FIG. 1 to FIG. 6 which were explained in the first exemplified embodiment.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

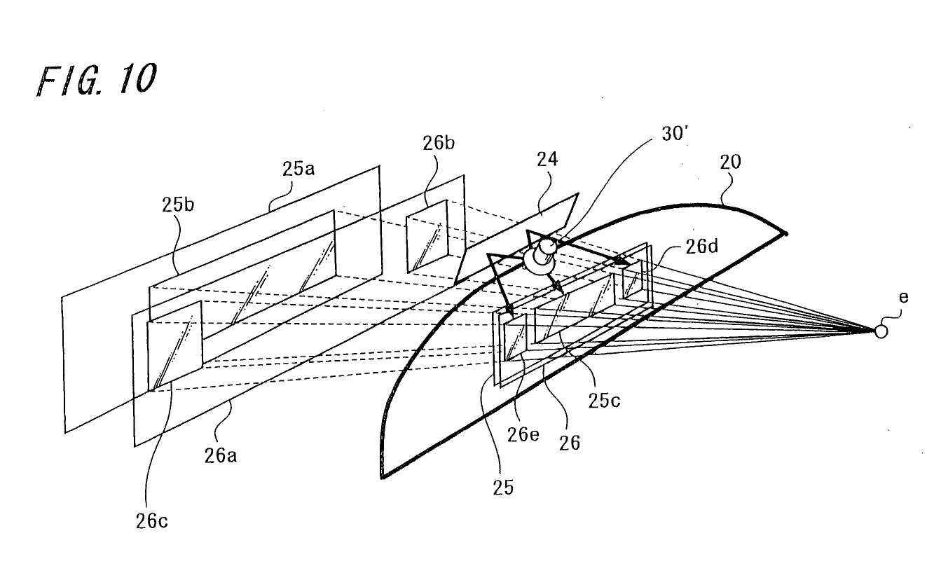

In this exemplified embodiment, it is constituted such that the arrangement position of the wide-angle azimuth projector 30 in the console 20 is set at a position different from the arrangement position explained in the first exemplified embodiment. Specifically, it is constituted as shown in FIG. 7 and FIG. 8 such that with respect to the arrangement position of hologram films 21′, 22′ and 23′ to the console 20, it is made to be approximately the same as the arrangement position of the hologram films 21, 22 and 23 shown in FIG. 1 and FIG. 9 according to the first exemplified embodiment, but with respect to the wide-angle azimuth projector 30, it is arranged at a position 20a which becomes a position on the inner side of the hologram films 21′ , 22′ and 23′ (that is, on the back side of the film seen from the driver observing point e) so as to carry out the projection from the inner side of the films 21′, 22′ and 23′ (opposite side of the observing point e).

However, as shown in FIG. 8, with respect to the arrangement of the right and left hologram films 22′ and 23′, while the end portions of the films 22 and 23 of the FIG. 1 example were inclined to the observing point e side, the hologram films 22′ and 23′ of this example are inclined to the opposite side.

By employing the constitution of this second exemplified embodiment, similarly as the first exemplified embodiment, with respect to the images seen from the driver observing point e, as shown in FIG. 8, the virtual image 21b which the rear center camera 11 imaged is displayed at the back center of the console 20, the virtual images 22b and 23b which the rear right camera 12 and the rear left camera 13 imaged are displayed by being inclined obliquely to the right and left slightly before the virtual image 21b, and it becomes a display mode in which the positional relation between the rear portion and the right and left side portions can be comprehended easily. Further, with respect to the images 22b and 23b imaging the right and left side portions, they are at the positions to be displayed obliquely with predetermined angles and it is similar as in the first exemplified embodiment with respect to the aspects in which the images of the right and left side portions are displayed in a form closer to the actual imaging directions and it becomes easy to comprehend that they are the right and left side portions.

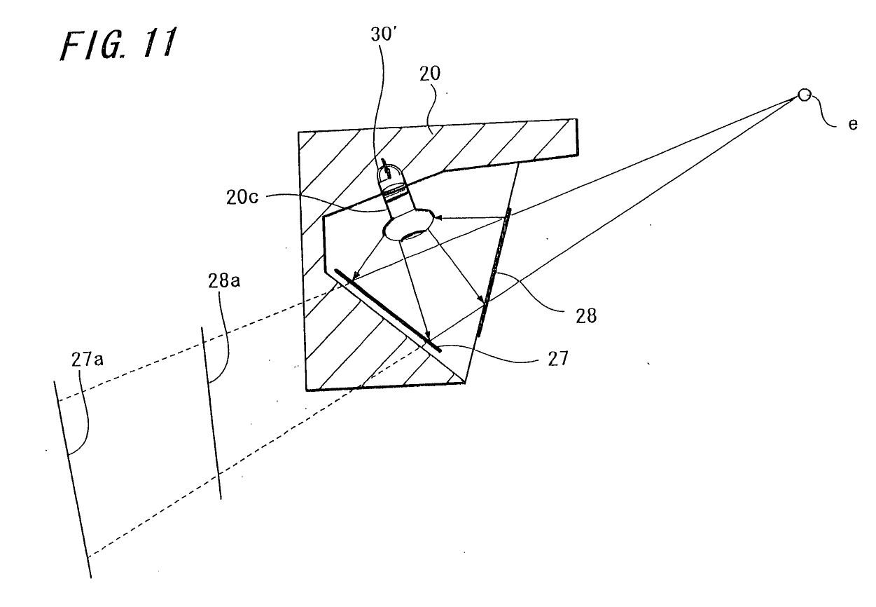

Next, a third exemplified embodiment of the present invention will be explained with reference to FIG. 9 and FIG. 10. In these FIG. 9 and FIG. 10, the same reference numerals are put for the portions corresponding to those of FIG. 1 to FIG. 8 which were explained in the first and second exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, it is constituted similarly as the arrangement position explained in the second exemplified embodiment such that an arrangement position of a wide-angle azimuth projector 30′ in the console 20 is to be the inner side of the hologram films and at the same time the hologram films are arranged by being overlapped. The wide-angle azimuth projector 30′ arranged at a predetermined position 20b in the console 20 is constituted by excluding the light shielding member 31c from the wide-angle azimuth projector 30 explained in the first exemplified embodiment with reference to FIG. 4 and FIG. 5 in which limitation of the projection directions is eliminated.

Then, in this example, as shown in FIG. 9 and FIG. 10, two of hologram films 25 and 26 are arranged by being overlapped, a first virtual screen 25a is formed by the hologram film 25 for the first image at the center back seen from the driver observing point e, and a center back virtual image 25b is displayed as shown in FIG. 10. The center back virtual image 25b is an image which the rear center camera 11 imaged. Also, by using the hologram film 26 for the second image, a second virtual screen 26a is formed before the first virtual screen 25a. With respect to the virtual image on the second virtual screen 26a constituted by the hologram film 26 for the second image, as shown in FIG. 10, a back right virtual image 26b is displayed at a position which is immediate right of the back center virtual image 25b seen from the driver observing point e and a back left virtual image 26c is displayed at a position which is immediate left of the back center virtual image 25b. The back right virtual image 26b is an image which the rear right camera 12 imaged and the back left virtual image 26c is an image which the rear left camera 13 imaged.

In this case, it is constituted as shown in FIG. 9 such that a projection image light H1 projected from the wide-angle azimuth projector 30′ to the hologram film 25 for the first image is projected directly from the projector 30′ to the hologram film 25 for the first image and a projection image light H2 projected from the wide-angle azimuth projector 30′ to the hologram film 26 for the second image is projected from the projector 30′ to the hologram film 26 for the second image after being reflected by a reflecting mirror 24.

In case of the constitutional example of these FIG. 9 and FIG. 10, similarly as in the case of the first and second exemplified embodiments, the display position of the back center virtual image 25b and the display position of the back right virtual image 26b and the back left virtual image 26c are also different backward and forward, it becomes a display positional relation approximately equal to the actually imaging positional relation, and it becomes a display mode in which the positional relation between the rear portion and the right and left side portions can be easily comprehended.

In this case, two pieces of the hologram films 25 and 26 are enough in this example, so that it is possible to make the constitution of the display apparatus simpler as much.

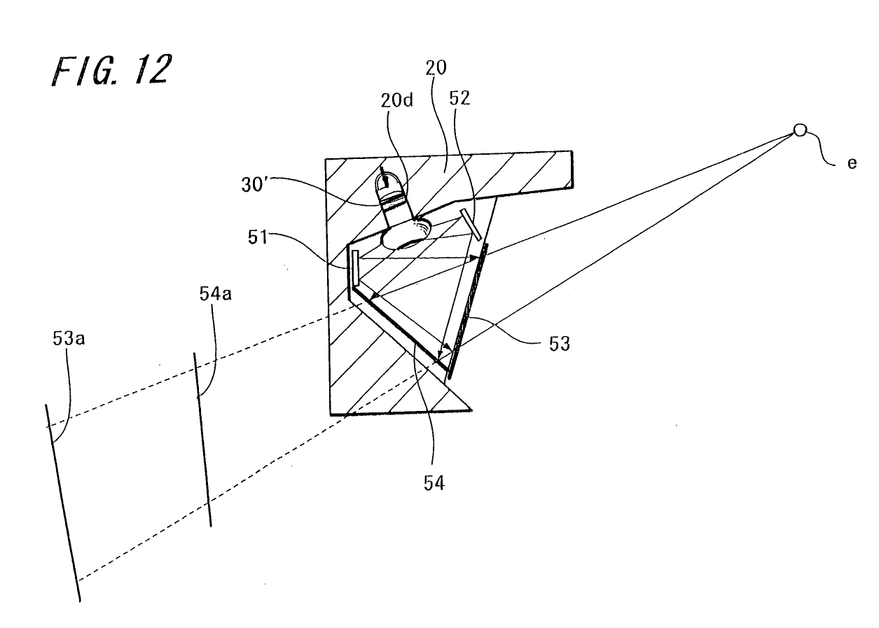

Next, a fourth exemplified embodiment of the present invention will be explained with reference to FIG. 11. In this FIG. 11, the same reference numerals are put for the portions corresponding to those of FIG. 1 to FIG. 10 which were explained in the first, second and third exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, it is constituted similarly as the arrangement position explained in the third exemplified embodiment such that an arrangement position of a wide-angle azimuth projector 30′ in the console 20 is to be the inner side of the hologram films and two pieces of hologram films are used, but it is constituted such that the two pieces of the hologram films 27 and 28 are arranged without being overlapped. The wide-angle azimuth projector 30′ arranged at a predetermined position 20c in the console 20 is the wide-angle azimuth projector 30′ without the light shielding member 31c explained in the third exemplified embodiment.

Then, in this example, as shown in FIG. 11, two of hologram films 27 and 28 are arranged at different positions in the console 20, a first virtual screen 27a is formed by the hologram film 27 for the first image at the center back seen from the driver observing point e, and a center back virtual image 27b is displayed. The center back virtual image is an image which the rear center camera 11 imaged. Also, by using the hologram film 28 for the second image, a second virtual screen 28a is formed before the first virtual screen 27a. With respect to the virtual image on the second virtual screen 28a constituted by the hologram film 28 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

In this case, in this example, it is constituted as shown in FIG. 11 such that a projection image light projected from the wide-angle azimuth projector 30′ to the hologram film 27 for the first image and a projection image light projected from the wide-angle azimuth projector 30′ to the hologram film 28 for the second image are projected directly from the projector 30′ to the respective hologram films 27 and 28 respectively.

Also in case of the constitutional example of this FIG. 11, a similar effect can be obtained as in the case of the third exemplified embodiment.

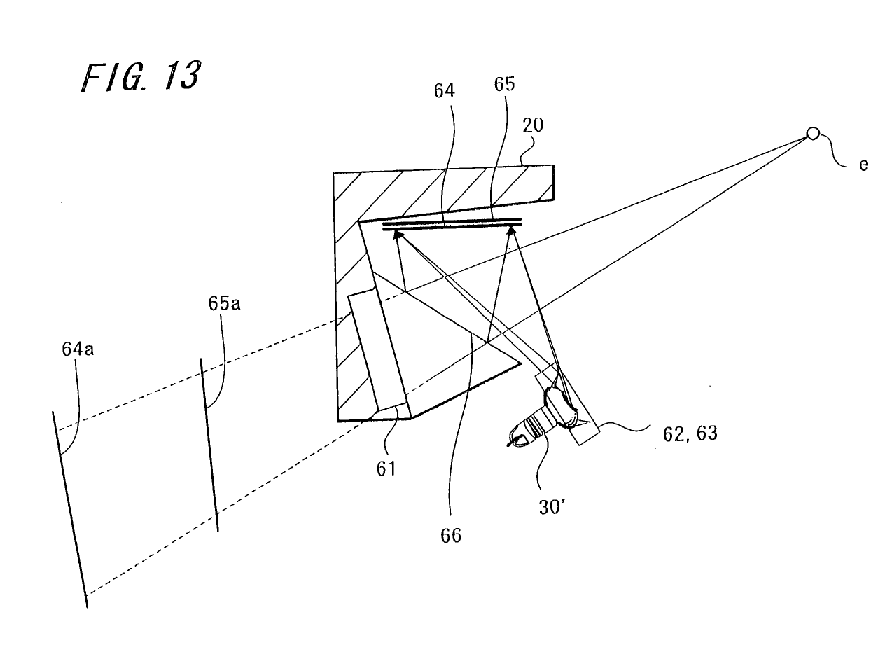

Next, a fifth exemplified embodiment of the present invention will be explained with reference to FIG. 12. In this FIG. 12, the same reference numerals are put for the portions corresponding to those of FIG. 1 to FIG. 11 which were explained in the first to the fourth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, it is constituted similarly as the arrangement position explained in the fourth exemplified embodiment such that the two pieces of the hologram films 53 and 54 are arranged without being overlapped. The wide-angle azimuth projector 30′ arranged at a predetermined position 20d in the console 20 is the wide-angle azimuth projector 30′ without the light shielding member 31c explained in the third exemplified embodiment.

Then, in this example, as shown in FIG. 12, two of hologram films 53 and 54 are arranged at different positions in the console 20, a first virtual screen 53a is formed by the hologram film 53 for the first image at the center back seen from the driver observing point e, and a center back virtual image 53b is displayed. The center back virtual image is an image which the rear center camera 11 imaged. Also, by using the hologram film 54 for the second image, a second virtual screen 54a is formed before the first virtual screen 53a. With respect to the virtual image on the second virtual screen 54a constituted by the hologram film 54 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

Then, in this example, it is constituted as shown in FIG. 11 such that a projection image light projected from the wide-angle azimuth projector 30′ to the hologram film 27 for the first image and a projection image light projected from the wide-angle azimuth projector 30′ to the hologram film 28 for the second image are projected to the respective hologram films 53 and 54 after being reflected by reflecting mirrors 51 and 52 respectively.

Also in case of the constitutional example of this FIG. 12, a similar effect can be obtained as in the case of the third and fourth exemplified embodiments.

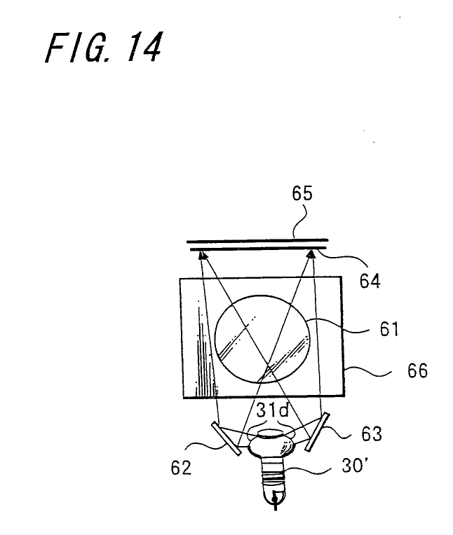

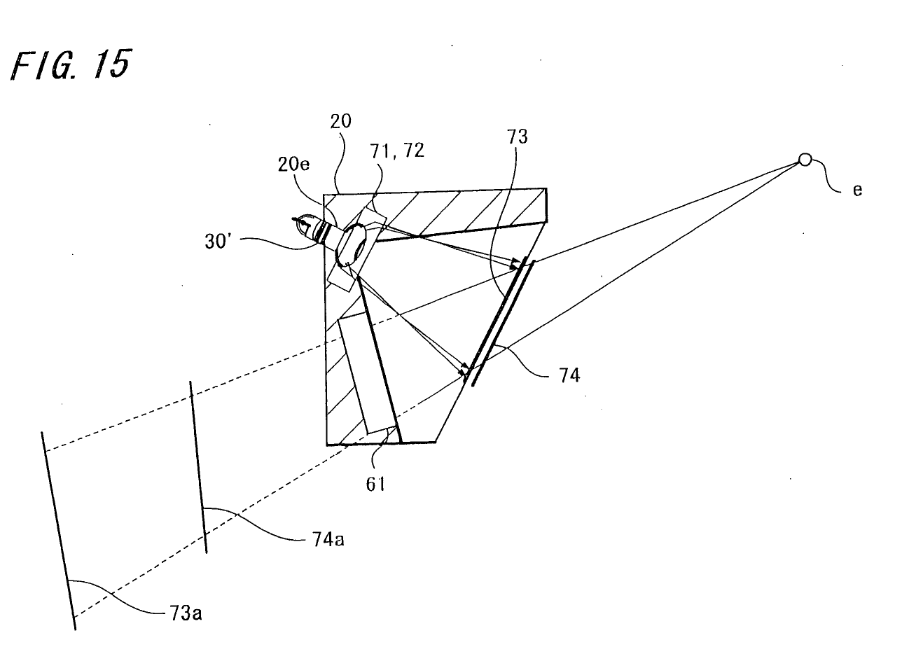

Next, a sixth exemplified embodiment of the present invention will be explained with reference to FIG. 13 and FIG. 14. In these FIG. 13 and FIG. 14, the same reference numerals are put for the portions corresponding to those of FIG. 1 to FIG. 12 which were explained in the first to the fifth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, there is provided in the console 20 with a liquid crystal display 61 carrying out various kinds of displays for a speed meter or the like and it is constituted such that an image of a type of a meter displayed on the liquid crystal display 61 and the images displayed on the two pieces of hologram films 64 and 65 are displayed by being overlapped. In order to carry out a synthesize display in this manner, a half mirror 66 is arranged in the console 20 as shown in FIG. 13. FIG. 14 is a diagram seeing the half mirror 66 from the front thereof.

As shown in FIG. 14, there are arranged two of reflecting mirrors 62 and 63 on the side of the wide-angle azimuth projector 30′ in which a projection light reflected by the reflecting mirror 62 is inputted to the hologram film 64, a first virtual screen 64a is formed at a place back from the liquid crystal display 61 seen from the driver observing point e, and the back center virtual image is to be displayed. The center back virtual image is an image which the rear center camera 11 imaged. Also, a projection light reflected by the reflecting mirror 63 is inputted to the hologram film 65 and a second virtual screen 65a is formed by the hologram film 65 for a second image at a position before the first virtual screen 64a. With respect to the virtual image on the second virtual screen 65a constituted by the hologram film 65 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

Also in case of the constitutional example of these FIG. 13 and FIG. 14, a similar effect can be obtained as in the case of the third to fifth exemplified embodiments and at the same time it is possible to overlap with the display of the liquid crystal display 61 on which a meter or the like is displayed, so that many different kinds of display modes will become available. Here, it is not always necessary to carry out the display on the liquid crystal display 61 and the display according to the hologram films 64 and 65 concurrently.

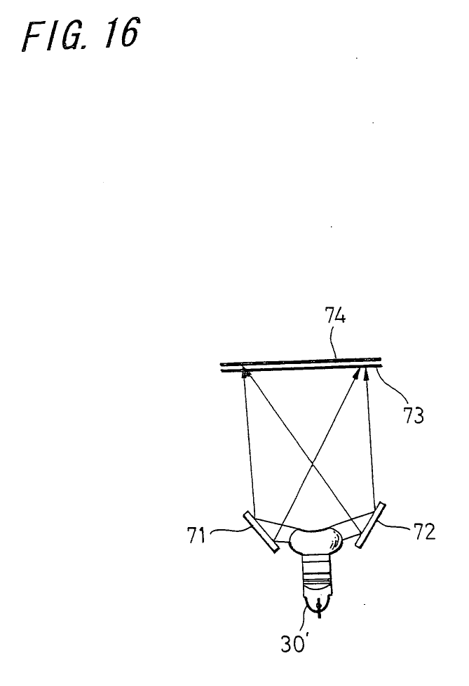

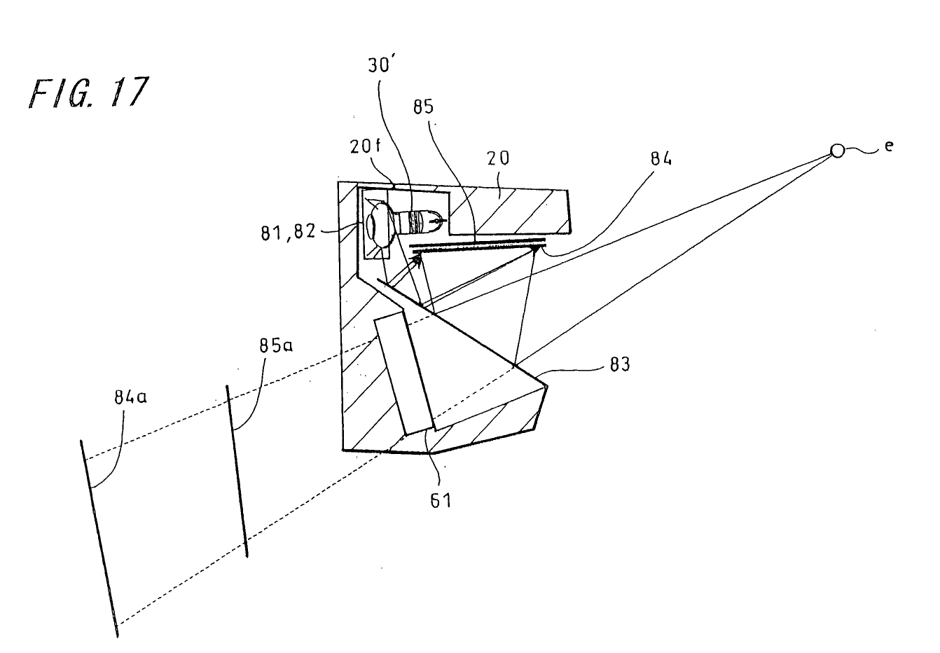

Next, a seventh exemplified embodiment of the present invention will be explained with reference to FIG. 15 and FIG. 16. In these FIG. 15 and FIG. 16, the same reference numerals are put for the portions corresponding to those of FIG. 1 to FIG. 14 which were explained in the first to the sixth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, there is provided in the console 20 with a liquid crystal display 61 carrying out various kinds of displays for a speed meter or the like and it is constituted such that an image of a type of a meter displayed on the liquid crystal display 61 and the images displayed on the two pieces of hologram films 64 and 65 are displayed by being overlapped in which the arrangement state of the wide-angle azimuth projector 30′ and hologram films 73 and 74 is changed from that of the sixth exemplified embodiment. In this example, a half mirror is not used and it is constituted such that the synthesis is to be carried out on the hologram films 73 and 74. FIG. 16 is a diagram seeing the projection state from the upper side thereof.

As shown in FIG. 15 and FIG. 16, there are arranged two of reflecting mirrors 71 and 72 on the side of the wide-angle azimuth projector 30′ in which a projection light reflected by the reflecting mirror 71 is inputted to the hologram film 73, a first virtual screen 73a is formed at a place back from the liquid crystal display 61 seen from the driver observing point e, and the back center virtual image is to be displayed. The center back virtual image is an image which the rear center camera 11 imaged. Also, a projection light reflected by the reflecting mirror 72 is inputted to the hologram film 74 and a second virtual screen 74a is formed by the hologram film 74 for a second image at a position before the first virtual screen 73a. With respect to the virtual image on the second virtual screen 74a constituted by the hologram film 74 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

Also in case of the constitutional example of these FIG. 15 and FIG. 16, a similar effect can be obtained as in the case of the sixth exemplified embodiment. Also in case of this example, it is not always necessary to carry out the display on the liquid crystal display 61 and the display according to the hologram films 73 and 74 concurrently.

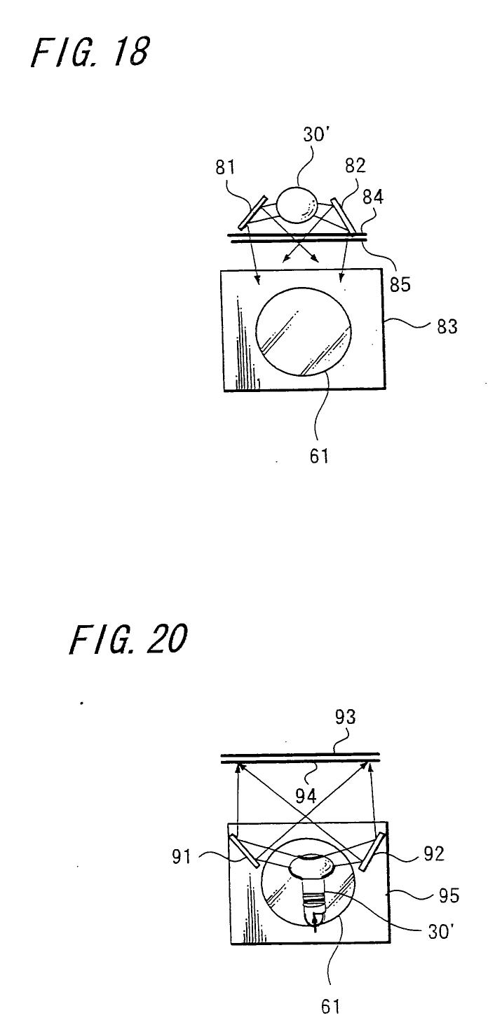

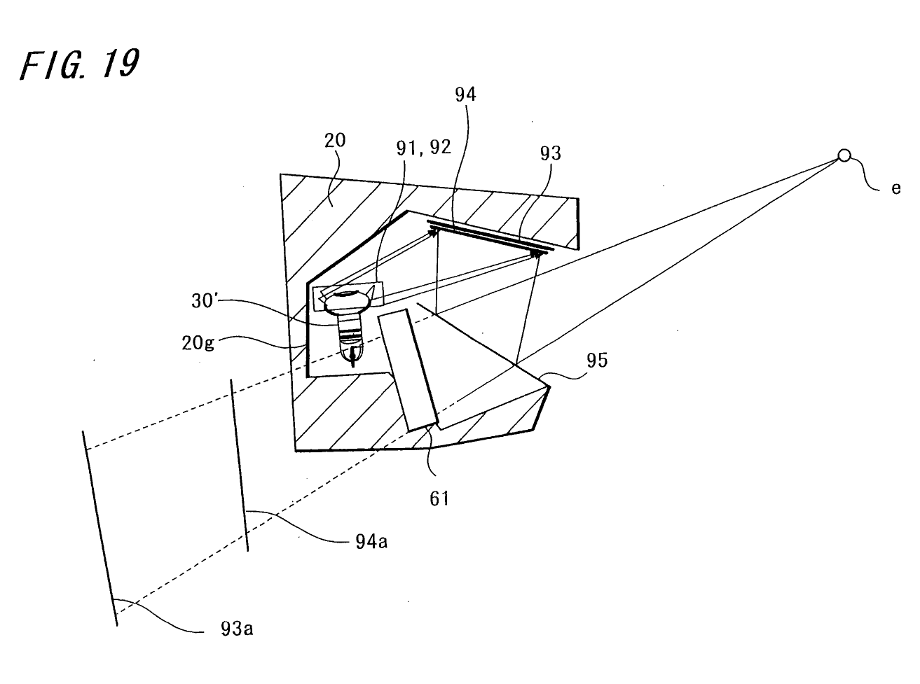

Next, an eighth exemplified embodiment of the present invention will be explained with reference to FIG. 17 and FIG. 18. In these FIG. 17 and FIG. 18, the same reference numerals are put for the portions corresponding to those of FIG. 1 to FIG. 16 which were explained in the first to the seventh exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, there is provided in the console 20 with a liquid crystal display 61 carrying out various kinds of displays for a speed meter or the like and it is constituted such that an image of a type of a meter displayed on the liquid crystal display 61 and the images displayed on the two pieces of hologram films 84 and 85 are displayed by being overlapped in which the arrangement state of the wide-angle azimuth projector 30′ and hologram films 84 and 85 is changed from that of the sixth exemplified embodiment. In this example, a half mirror 83 is used, but it constituted as shown in FIG. 17 such that the projection light from the wide-angle azimuth projector 30′ is reflected by two of reflecting mirrors 81 and 82, thereafter is reflected once by the upper end of the half mirror 83 and then is projected to the hologram films 84 and 85 which are arranged by being overlapped in which the image lights reflected by the hologram films 84 and 85 are to be synthesized with the display of the liquid crystal display 61on the half mirror 83. FIG. 18 is a diagram seeing the half mirror 83 from the front thereof.

As shown in FIG. 17 and FIG. 18, there are arranged two of reflecting mirrors 81 and 82 on the side of the wide-angle azimuth projector 30′ which is arranged at a predetermined position 20f in the console 20 wherein a projection light reflected by the reflecting mirror 81 is inputted to the hologram film 84 through the half mirror 83, a first virtual screen 84a is formed at a place back from the liquid crystal display 61 seen from the driver observing point e, and the back center virtual image is to be displayed. The center back virtual image is an image which the rear center camera 11 imaged. Also, a projection light reflected by the reflecting mirror 82 is inputted to the hologram film 85 through the half mirror 83 and a second virtual screen 85a is formed by the hologram film 85 for a second image at a position before the first virtual screen 84a. With respect to the virtual image on the second virtual screen 85a constituted by the hologram film 85 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

Also in case of the constitutional example of these FIG. 17 and FIG. 18, a similar effect can be obtained as in the case of the seventh exemplified embodiment. Also in case of this example, it is not always necessary to carry out the display on the liquid crystal display 61 and the display according to the hologram films 84 and 85 concurrently.

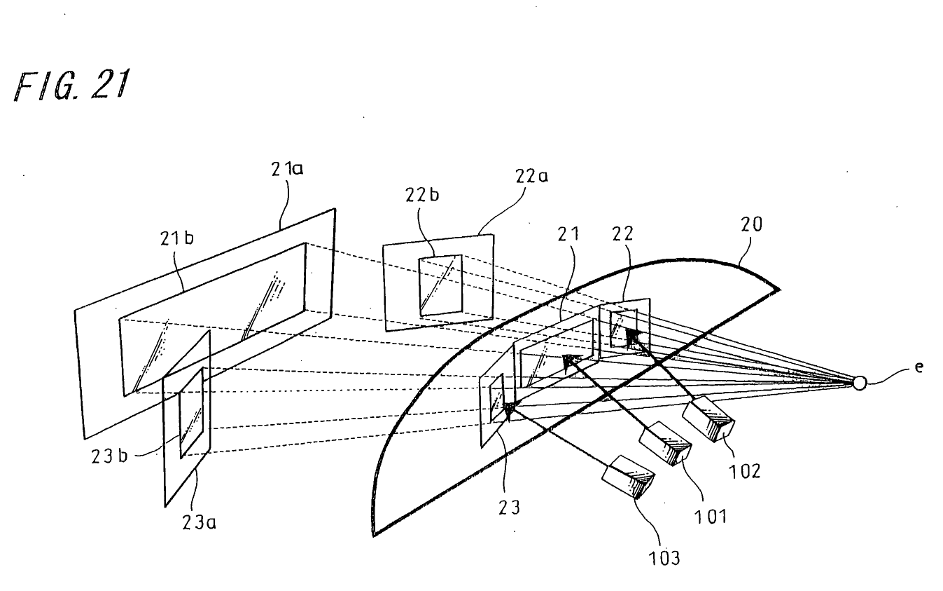

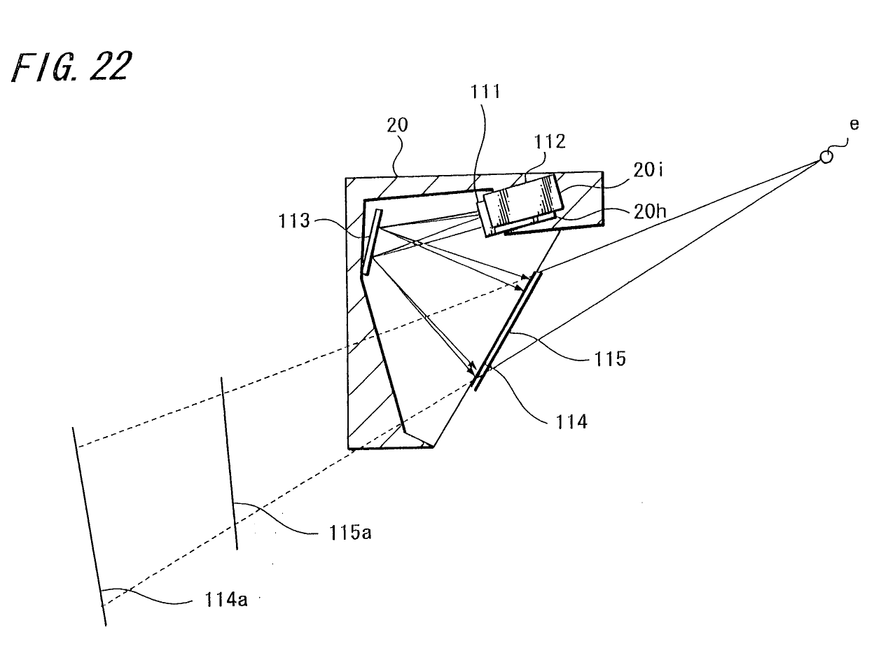

Next, a ninth exemplified embodiment of the present invention will be explained with reference to FIG. 19 and FIG. 20. In these FIG. 19 and FIG. 20, the same reference numerals are put for the portions corresponding to those of FIG. 1 to FIG. 18 which were explained in the first to the eighth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, there is provided in the console 20 with a liquid crystal display 61 carrying out various kinds of displays for a speed meter or the like and it is constituted such that an image of a type of a meter displayed on the liquid crystal display 61 and the images displayed on the two pieces of hologram films 93 and 94 are displayed by being overlapped in which the arrangement state of the wide-angle azimuth projector 30′ and hologram films 93 and 94 is changed from that of the sixth exemplified embodiment. In this example, a half mirror 95 is used, but it constituted as shown in FIG. 19 such that the projection light from the wide-angle azimuth projector 30′ is reflected by two of reflecting mirrors 91 and 92 and thereafter is projected to the hologram films 93 and 94 which are arranged by being overlapped in which the image lights reflected by the hologram films 93 and 94 are to be synthesized with the display of the liquid crystal display 61 on the half mirror 95. FIG. 20 is a diagram seeing the half mirror 95 from the front thereof.

As shown in FIG. 19 and FIG. 20, there are arranged two of reflecting mirrors 91 and 92 on the side of the wide-angle azimuth projector 30′ which is arranged at a predetermined position 20g in the console 20 wherein a projection light reflected by the reflecting mirror 91 is inputted to the hologram film 93, a first virtual screen 93a is formed at a place back from the liquid crystal display 61 seen from the driver observing point e, and the back center virtual image is to be displayed. The center back virtual image is an image which the rear center camera 11 imaged. Also, a projection light reflected by the reflecting mirror 92 is inputted to the hologram film 94 and a second virtual screen 94a is formed by the hologram film 94 for a second image at a position before the first virtual screen 93a. With respect to the virtual image on the second virtual screen 94a constituted by the hologram film 94 for the second image, similarly as the example shown in FIG. 10, a back right virtual image is displayed at a position which is immediate right of the back center virtual image seen from the driver observing point e and a back left virtual image is displayed at a position which is immediate left of the back center virtual image. The back right virtual image is an image which the rear right camera 12 imaged and the back left virtual image is an image which the rear left camera 13 imaged.

Also in case of the constitutional example of these FIG. 19 and FIG. 20, a similar effect can be obtained as in the case of the seventh exemplified embodiment. Also in case of this example, it is not always necessary to carry out the display on the liquid crystal display 61 and the display according to the hologram films 93 and 94 concurrently.

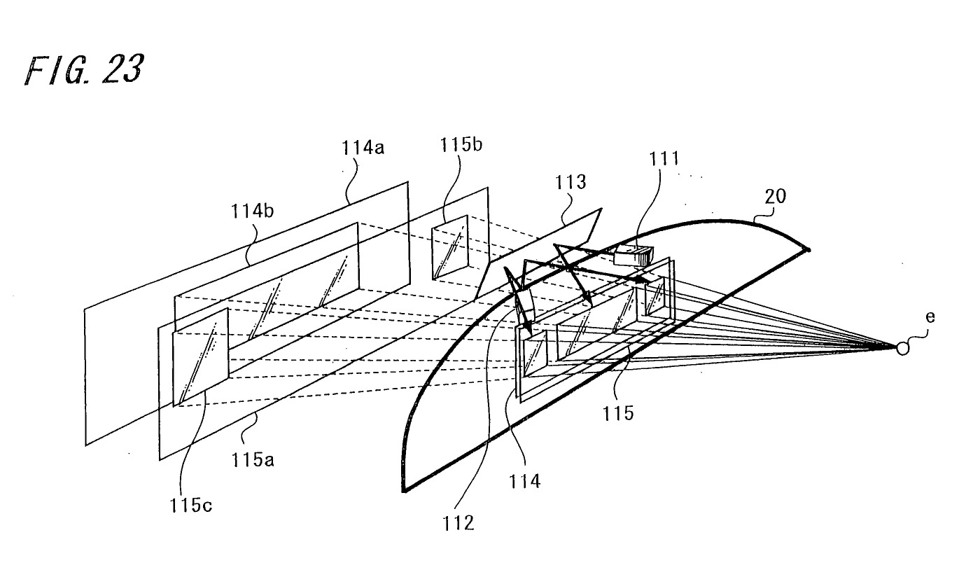

Next, a tenth exemplified embodiment of the present invention will be explained with reference to FIG. 21. In this FIG. 21, the same reference numerals are put for the portions corresponding to those of FIG. 1 to FIG. 20 which were explained in the first to the ninth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, it is constituted such that individual projectors 101, 102 and 103 are used for the respective images while one wide-angle azimuth projector 30 or 30′ was used in the examples so far. More specifically, similarly as the first exemplified embodiment, there are arranged three of hologram films 21, 22 and 23 in the console 20 as shown in FIG. 21 in which the three of hologram films 21, 22 and 23 receive projections from the three of projectors 101, 102 and 103 individually. A configuration is employed in which the three of hologram films 21, 22 and 23 are arranged in one row laterally, the central hologram film 21 is made to be in a landscape shape, and the hologram films 22 and 23 which are immediate right and immediate left thereof are arranged by being inclined slightly obliquely such that the images are to be displayed obliquely with a predetermined angle.

By doing in this manner, on the first virtual screen 21a displayed according to the central hologram film 21a, there is displayed a virtual image 21b which the rear center camera 11 imaged by being projected from the projector 101. On the second virtual screen 22a displayed according to the hologram film 22 on the right side, there is displayed the virtual image 22b which the rear right camera 12 imaged by being projected from the projector 102. On the third virtual screen 23a displayed according to the hologram film 23 on the left side, there is displayed the virtual image 23b which the rear left camera 13 imaged by being projected from the projector 103.

In case of the constitutional example of this FIG. 21, images are displayed similarly as the first exemplified embodiment and a similar effect can be obtained.

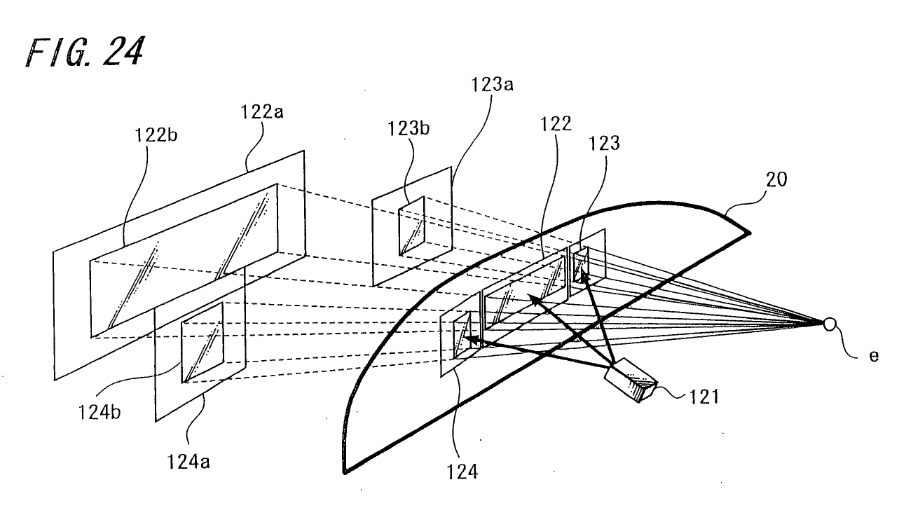

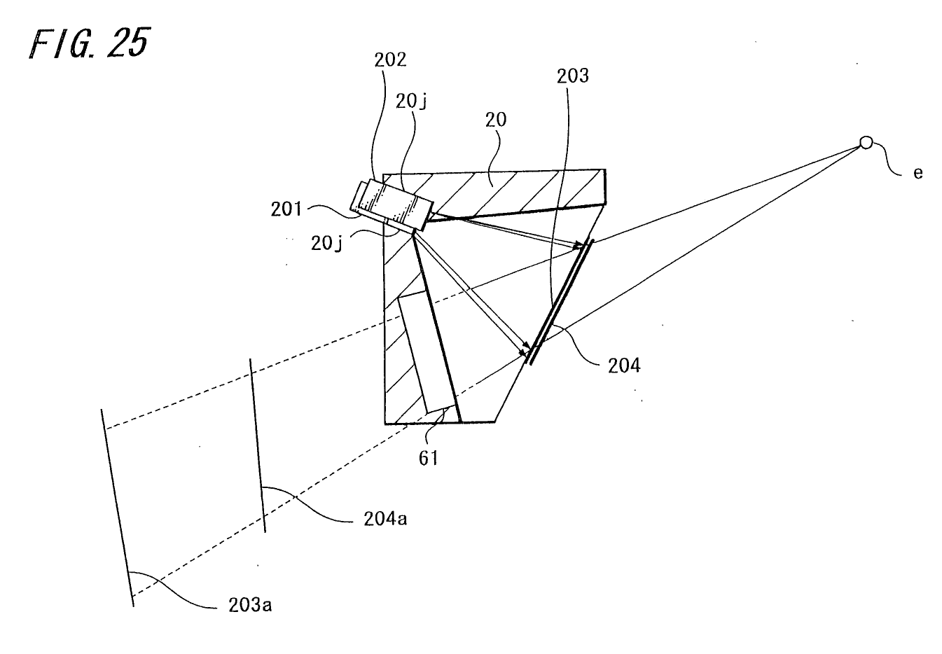

Next, an eleventh exemplified embodiment of the present invention will be explained with reference to FIG. 22 and FIG. 23. In these FIG. 22 and FIG. 23, the same reference numerals are put for the portions corresponding to those of FIG. 1 to FIG. 21 which were explained in the first to the tenth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

Also in this exemplified embodiment, it is constituted such that a plurality of (here, two of) projectors 111 and 112 are used without using one common wide-angle azimuth projector 30 or 30′. More specifically, similarly as the third exemplified embodiment shown in FIG. 10, there are arranged two of hologram films 114 and 115 in the console 20 in which image lights from the two of projectors 111 and 112 are reflected by a reflecting mirror 113 and projected to the two of hologram films 114 and 115 individually.

In this example, as shown in FIG. 22 and FIG. 23, two of hologram films 114 and 115 are arranged by being overlapped, a first virtual screen 114a is formed by the hologram film 114 for the first image at the center back seen from the driver observing point e, and a center back virtual image 114b is displayed as shown in FIG. 23. The center back virtual image 114b is an image which the rear center camera 11 imaged. Also, by using the hologram film 115 for the second image, a second virtual screen 115a is formed before the first virtual screen 114a. With respect to the virtual image on the second virtual screen 115a constituted by the hologram film 115 for the second image, as shown in FIG. 23, a back right virtual image 115b is displayed at a position which is immediate right of the back center virtual image 114b seen from the driver observing point e and a back left virtual image 115c is displayed at a position which is immediate left of the back center virtual image 114b. The back right virtual image 115b is an image which the rear right camera 12 imaged and the back left virtual image 115c is an image which the rear left camera 13 imaged.

Also in case of the constitutional example of these FIG. 22 and FIG. 23, similarly as in the case of the third exemplified embodiment, the display position of the back center virtual image 114b and the display position of the back right virtual image 115b and the back left virtual image 115c are different backward and forward, it becomes a display positional relation approximately equal to the actually imaging positional relation, and it becomes a display mode in which the positional relation between the rear portion and the right and left side portions can be easily comprehended.

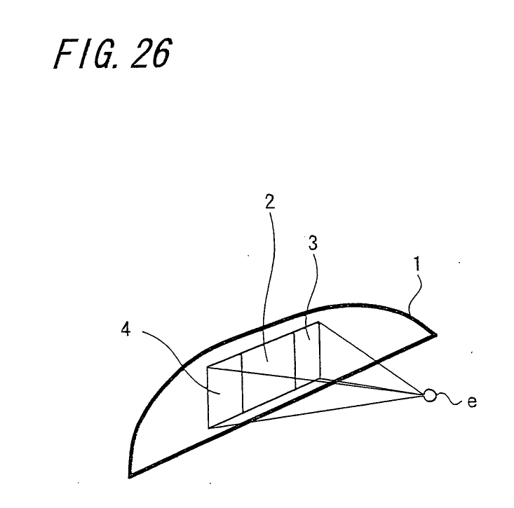

Next, a twelfth exemplified embodiment of the present invention will be explained with reference to FIG. 24. In this FIG. 24, the same reference numerals are put for the portions corresponding to those of FIG. 1 to FIG. 23 which were explained in the first to the eleventh exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, it is constituted such that a normal projector 121 is to be used without using the wide-angle azimuth projector 30 or 30′. More specifically, as shown in FIG. 24, three of hologram films 122, 123 and 124 are in the console 20 by being aligned laterally and projection lights from the single projector 121 is projected directly to the three of hologram films 122, 123 and 124 by changing projection angles respectively.

In this example, a first virtual screen 122a is formed by the hologram film 122 for the first image at the center back seen from the driver observing point e, and a center back virtual image 122b is displayed. The center back virtual image 122b is an image which the rear center camera 11 imaged. Also, by using the hologram film 123 for the second image, a second virtual screen 123a is formed at the right position before the first virtual screen 122a. With respect to the virtual image on the second virtual screen 123a constituted by the hologram film 123 for the second image, a back right virtual image 123b is displayed at a position which is immediate right of the back center virtual image 122b seen from the driver observing point e. Further, by using the hologram film 124 for the third image, a third virtual screen 124a is formed at the left position before the first virtual screen 122a. With respect to the virtual image on the third virtual screen 124a constituted by the hologram film 124 for the third image, a back left virtual image 124b is displayed at a position which is immediate left of the back center virtual image 122b seen from the driver observing point e.

Also in case of the constitutional example of these FIG. 24, the display position of the back center virtual image 122b and the display position of the back right virtual image 123b and the back left virtual image 124b are different backward and forward, it becomes a display positional relation approximately equal to the actually imaging positional relation, and it becomes a display mode in which the positional relation between the rear portion and the right and left side portions can be easily comprehended.

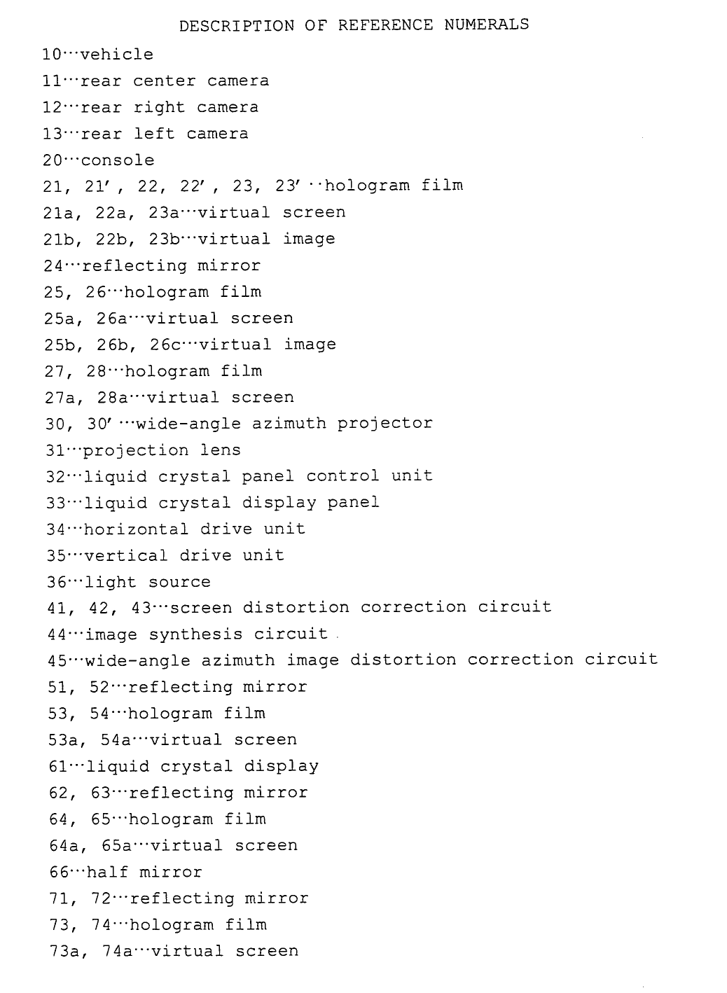

Next, a thirteenth exemplified embodiment of the present invention will be explained with reference to FIG. 25. In this FIG. 25, the same reference numerals are put for the portions corresponding to those of FIG. 1 to FIG. 24 which were explained in the first to the twelfth exemplified embodiments.

Also in this exemplified embodiment, similarly as in the first exemplified embodiment, it is constituted as an image display apparatus for a vehicle equipped in a vehicle such as a car and with respect to the arrangement of the three of video cameras, it is assumed to be the same as that shown in FIG. 2.

In this exemplified embodiment, normal type two of projectors 201 and 202 are used and at the same time there is provided in the console 20 with a liquid crystal display 61 carrying out various kinds of displays for a speed meter or the like and it is constituted such that an image of a type of a meter displayed on the liquid crystal display 61 and the images displayed on the two pieces of hologram films 203 and 204 are displayed according to the two of projectors 201 and 202 by being overlapped.

In this example, a first virtual screen 203a is formed by the hologram film 203 for the first image at the center back seen from the driver observing point e, and a center back virtual image is displayed. The center back virtual image is an image which the rear center camera 11 imaged. Also, by using the hologram film 204 for the second image, a second virtual screen 204a is formed at the position before the first virtual screen 203a. With respect to the virtual image on the second virtual screen 204a constituted by the hologram film 204 for the second image, a back right virtual image is displayed at a position which is immediate right of the back center virtual image and a back left virtual image is displayed at a position which is immediate left of the back center virtual image seen from the driver observing point e.

Also in case of the constitutional example of these FIG. 25, the display position of the back center virtual image and the display position of the back right virtual image and the back left virtual image are different backward and forward, it becomes a display positional relation approximately equal to the actually imaging positional relation, and it becomes a display mode in which the positional relation between the rear portion and the right and left side portions can be easily comprehended.

It should be noted in each of the exemplified embodiments so far explained that although this invention is applied to a case in which imaging means are provided at a rear portion and right and left side portions of a vehicle which is a car and images which the imaging means imaged are displayed in a console arranged ahead of a driving seat, it is applicable also to a case in which images which were imaged by imaging means arranged at a plurality of other different positions are displayed concurrently. With respect also to a vehicle equipped with this apparatus, it is not limited to a car such as shown in FIG. 2 and it is applicable to various kinds of vehicles.

Also, although the three of images were configured to be aligned in one row laterally in the above mentioned exemplified embodiments, it may be constituted, for example, such that positional relations of cameras in up and bottom directions are to be comprehended from displays by displacing the imaginarily displayed positions also in up and down direction.

Further, while it was constituted in the above mentioned exemplified embodiments such that virtual images are displayed at a plurality of different positions by two or three of hologram films, it may be constituted by one (one piece) of hologram film in a case when it is possible to configure virtual images at a plurality of different positions by using one (one piece) of hologram film.

1. In an image display apparatus for a vehicle which is equipped in a vehicle and displays outputs of a plurality of imaging means imaging positions of different directions respectively, an image display apparatus for a vehicle comprising:
projection means for projecting the output images of said plurality of imaging means; and
a hologram film in which the output image of said projection means is projected, a projection image is displayed imaginarily at a position different from an actual arrangement position, and at the same time the position on which the projection image is displayed imaginarily is made to be at lease two different positions.

2. In an image display apparatus for a vehicle according to claim 1, an image display apparatus for a vehicle, wherein
said a plurality of imaging means are three of imaging means for imaging a rear portion and right and left side portions the vehicle; and
said hologram film is configured such that a virtual display position of an output of the imaging means for imaging the rear portion of the vehicle is set at a back portion compared with virtual display positions of outputs of the imaging means for imaging the right and left side portions of the vehicle.

3. In an image display apparatus for a vehicle according to claim 2, an image display apparatus for a vehicle,
wherein the virtual display positions of the outputs of the imaging means for imaging the right and left side portions of the vehicle are made to be positions at the right and the left before the virtual display position of the output of the imaging means for imaging the rear portion of the vehicle and also to be positions on which they are displayed obliquely with predetermined angles.

4. In an image display apparatus for a vehicle according to claim 2, an image display apparatus for a vehicle,
wherein the virtual display positions of the outputs of the imaging means for imaging the right and the left side portions of the vehicle are arranged at the right and the left on a same plane.

5. In an image display apparatus for a vehicle according to claim 1, an image display apparatus for a vehicle,
wherein there is used for said projection means a projection means including an optical system in which a projection for 360° is possible; and projections to said plurality of hologram films are carried out by utilizing limited plurality of projection directions of the projection means.

6. In an image display apparatus for a vehicle according to claim 1, an image display apparatus for a vehicle, wherein
there are provided with a plurality of means for said projection means corresponding to the number of said a plurality of imaging means; and
the output images of the respective imaging means are projected to respective individual hologram films by means of respective individual projection means.

7. In an image display apparatus for a vehicle according to claim 1, an image display apparatus for a vehicle, wherein
there is further provided with another display means; and
the image projected to said hologram film and the image displayed on said display means are displayed by being synthesized.

8. In an image display apparatus for a vehicle according to claim 1, an image display apparatus for a vehicle, wherein
a half mirror is included as means for carrying out synthesis of the image projected to said hologram film and the image displayed on said display means.
